(19) United States
(12) Patent Application Publication
(10) Pub. No.: US 2025/0202676 A1
(43) Pub. Date: Jun. 19, 2025

(54) Method for monitoring a Half Duplex Ethernet network and associated Half Duplex Ethernet network

(71) Applicant: THALES, Meudon (FR)

(72) Inventors: Mael CHAPUIS, MERIGNAC (FR); Arnaud SITBON, MERIGNAC (FR)

(21) Appl. No.: 18/977,922

(22) Filed: Dec. 12, 2024

(30) Foreign Application Priority Data
Dec. 19, 2023 (FR) 2314500

(51) Int. Cl. H04L 5/16; H04W 74/0808

(52) U.S. Cl. CPC H04L 5/16; H04W 74/0808

(57) ABSTRACT

A method for monitoring a Half Duplex Ethernet network including a plurality of nodes and having a PLCA operating mode and a CSMA/CD operating mode, each node being defined by an identifier. The method includes retrieving an internal state of the node describing the operating mode of the network, transmitting the internal state to all other nodes, analyzing the external states received corresponding to the internal states sent by other nodes, and based on the analysis, reconfiguring the node or conserving the current configuration thereof.

### REFERENCE TO RELATED APPLICATION

This application is a U.S. non-provisional application claiming the benefit of French Patent Application No. 23 14500 filed on Dec. 19, 2023, the contents of which are incorporated herein by reference in their entirety.

### FIELD OF THE INVENTION

The present invention relates to a method for monitoring a Half Duplex Ethernet network. The present invention further relates to such a Half Duplex Ethernet network.

In particular, the Half Duplex Ethernet network according to the invention is as per one of the following standards: 10BASE-T1S, 100BASE-T1S, 10BASE-T1L, 100BASE-T1L. These standards are as per the standard of the type IEEE STD 802.3cg type.

### BACKGROUND OF THE INVENTION

In a manner known per se, the networks of such type serve to transmit data coming, e.g., from a plurality of sensors, to a central switch. Such type of network is a Half Duplex network, insofar as same serves to send frames in both directions of circulation between the nodes forming the network on the same pair of conductors.

Furthermore, in a particular operating mode, such type of network implements a collision management technique optimized to use the maximum of the bandwidth available for exchanges between different nodes of the network.

Such operating mode is known as PLCA (Physical Layer Collision Avoidance) and is based mainly on the presence of a master node on the network that periodically sends a synchronization signal called BEACON.

The synchronization signal allows the other nodes to synchronize and determine their own opportunities to issue frames in the network.

The absence of the synchronization signal on the network, due, e.g., to a failure of the master node called Master, forces the different nodes of the network to reconfigure the collision management mode by switching from PLCA operating mode to a degraded operating mode called CSMA/CD (Carrier Sense Multiple Access/Collision Detection).

Switching to such a mode means a significant reduction in the performance of the network. Indeed, when the network is in such degraded operating mode, each node wishing to send a frame on the network first checks whether there is another node that is already sending frames on the network. In such a case, the first node will wait a random time before performing the test again.

In certain fields, and in particular in the field of avionics, the network of the aforementioned type is an advantageous alternative to the networks currently used.

For example, in the field of avionics, the use of network such as ARINC 429 is known to connect sensors to a centralized switch. However, such type of network that is as per that standard has a very low throughput, typically around 100 Kbit/s and is only unidirectional.

On the other hand, e.g., the 10BASE-T1S network has a throughput of 10 Mbit/s and the 100BASE-T1S network has a throughput of 100 Mbit/s.

In addition, a Half Duplex network that allows frames to be sent in both directions over the same pair of conductors would reduce the need for cables. Indeed, for the existing networks, a pair of conductors is needed to ensure the flow of frames in each direction.

However, replacing existing networks with such type of network has a number of difficulties.

More particularly, when the network, e.g., a 10BASE-T1S network, switches to the degraded operating mode thereof, the frame transmission time can no longer be limited.

Thereof then makes such a network non-deterministic. The use of non-deterministic networks is problematic in some fields, and in particular in the field of avionics.

### SUMMARY OF THE INVENTION

The goal of the present invention is to solve this problem and to make the Half Duplex Ethernet network (such as 10BASE-T1S, 100BASE-T1L, 10BASE-T1L, 100BASET-1L) deterministic.

As a result, the use of such network would be possible in many fields and in particular in the field of avionics.

To this end, the invention relates to a method for monitoring a Half Duplex Ethernet network including a plurality of nodes and having a PLCA operating mode and a CSMA/CD operating mode, each node being defined by an identifier.

In the PLCA operating mode, a master node sends a synchronization signal to all the other nodes to issue the frames thereof.

In the CSMA/CD operating mode, all nodes transmit the frames thereof at random time intervals.

The method includes the following steps implemented by each node:
recovery of an internal state of the node describing the operating mode of the network;
transmission of the internal state to all other nodes;
analysis of the external states received corresponding to the internal states sent by other nodes;
based on the analysis, reconfiguration of the node or conservation of the current configuration thereof.

According to other advantageous aspects of the invention, the method includes one or a plurality of the following features, taken individually or according to all technically possible combinations:
each internal state indicates the network operating mode seen by the corresponding node;
each internal state further indicates whether the corresponding node receives or sends a synchronization signal;
the step of transmission of the internal state includes the integration of the internal state in each frame issued by the corresponding node;
the reconfiguration step of each node includes a deactivation of the node or a shift of the identifier thereof;
the shift of the identifier includes:
   the allocation of a new identifier chosen according to the maximum number of nodes in the network when the corresponding node is the master node;
   the reduction of the identifier by “1” for all other cases;
the step of analysis of the external reports received includes a validation sub-step including the selection of a valid report from all the reports received;
the analysis step includes an analysis of at least three external states coming from different nodes;
the validation sub-step includes the comparison of the external states received and the selection of the valid state corresponding to a common state of a majority of the external states received;
the valid status indicates:
   the PLCA operation mode, the current configuration of the corresponding node is conserved;
   the CSMA/CD operating mode, the corresponding node is reconfigured by a shift of the identifier thereof;
   none of those operating modes, the corresponding node is reconfigured by a deactivation of the node;
the analysis step includes a sub-step of activating the CSMA/CD operating mode when the corresponding node does not receive any frames in a first time interval;
following the activation of the CSMA/CD operating mode, the reconfiguration step includes a shift of the identifier of the corresponding node when the node receives at least one frame in a second time interval and a deactivation of the node in the opposite case.

The invention further relates to a Half Duplex Ethernet network including a plurality of nodes and having a PLCA operating mode and a CSMA/CD operating mode, each node being defined by an identifier;
In the PLCA operating mode, a master node being apt to send a synchronization signal to all the other nodes to issue the frames thereof;
In the CSMA/CD operating mode, all nodes being apt to issue the frames thereof at random time intervals;
each node being configured to implement the method as defined hereinabove.

### BRIEF DESCRIPTION OF THE DRAWINGS

The invention will be clearer upon reading the following description, given only as an example, but not limited to, and making reference to the drawings wherein:

FIG. 1 is a schematic view of a Half Duplex Ethernet type network according to the invention, the network including in particular a plurality of nodes;

FIG. 2 is a flowchart of a monitoring method according to the network shown in FIG. 1;

FIGS. 3-7 are different illustrations of the implementation of the method of FIG. 2.

### DETAILED DESCRIPTION OF THE INVENTION

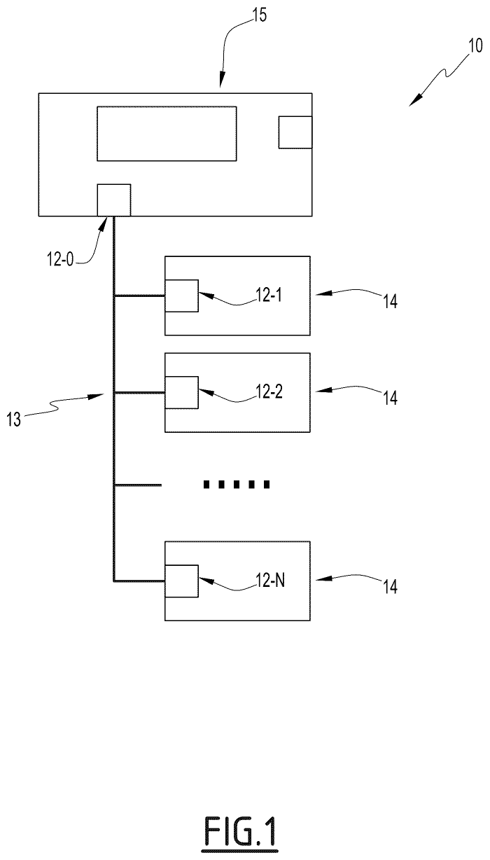

FIG. 1 shows indeed a network 10.

The network 10 is a Half Duplex Ethernet network that is as per one of the 10BASE-T1S, 100BASE-T1S, 10BASE-T1L or 100BASE-T1L standards. In general, such a standard is standardized in the standard of the type IEEE STD 802.3cg. “Standard of the type X” means the X standard of the current version or any later or earlier version where the version implements the features described in relation to the above standard.

As illustrated in FIG. 1, the network 10 includes a plurality of nodes 12-0, . . . 12-N which are connected by a cable 13. The cable 13 advantageously has a cable with a differential pair, e.g., a twisted pair cable.

Each of the nodes 12-0, . . . 12-N is integrated into a device which is apt to generate digital data in order to send same to other devices via the network 10 and/or to receive digital data from such devices. The digital data are transferred via the network 10 in the form of frames.

More particularly, according to one embodiment of the invention, the network 10 can be used in the field of avionics, e.g., the network 10 is carried on board an aircraft.

Aircraft refers to any flying vehicle which can be piloted at least partially manually and/or at least partially automatically.

According to an example of embodiment, at least some of the devices integrating the nodes 12-0, . . . 12-N have avionics sensors 14 and a device integrating at least one of the nodes has a switch 15. Such a switch 15 is configured to transmit data generated by the sensors to a centralized computer.

According to the above example, the data generated by the sensors 14 have, e.g., measurement data which are then sent to the central computer via the network 10 and in particular the switch 15.

Thereby, in the example of the main figure, the node 12-0 is integrated into such a switch 15 and the other nodes 12-1 to 12-N are integrated into the sensors 14.

Furthermore, the node 12-0 is also apt to send data to the other nodes. Such data have, e.g., configuration data of the corresponding sensors 14.

In a manner known per se, each node 12-0, . . . 12-N has a physical interface often implemented by a component called PHY. The physical interface PHY includes in particular an internal register storing different operating parameters of the node.

Moreover, each node 12-0, . . . 12-N is associated with a unique identifier in the network 10. For example, the identifiers of the nodes 12-0, . . . 12-N correspond to the node number allocated within the network and ranging from 0 to N.

The node identifiers can be changed, as will be described in more detail thereafter.

In a manner known per se, the network 10 has two modes of operation.

In a first operating mode, also called PLCA operating mode, all the exchanges of frames in the network 10 are controlled by a synchronization signal sent to all the nodes by the master node.

This master node usually has the identifier “0” which distinguishes same from other nodes in the network. The master node is then configured to periodically send a synchronization signal, also known as a BEACON. All the other nodes are apt to receive the synchronization signal and to send the frames thereof in a predetermined time slot for the corresponding node. The time slot is determined locally by the corresponding node using the synchronization signal. The master node is also configured to act like the other nodes, i.e., same is also configured to send frames in a specific time slot.

When the corresponding node does not have a frame to send in the slot thereof, the slot remains empty and no frame is sent in the network during the slot.

Advantageously, each slot may have a variable duration. For example, each slot can correspond to a period of time during which the node can begin sending. Each slot thus has a minimum duration corresponding to an absence of a frame, but the duration may extend to the duration of the frame to be sent in the presence of such a frame. In such a case, the next sending node will only start sending at the end of the frame transmission by the first node, i.e., the next sending node will only start sending after the detection of a “silence” in the network.

The second operating mode of the network 10, also known as the CSMA/CD operating mode, is triggered in the network when no synchronization signal is received by the nodes at the end of a cycle, i.e., after the speech time of all nodes. In such a case, each node is apt to send its frames at random time intervals, so as to prevent collisions. More particularly, when a node tries to send a frame while another node is sending another frame at the same time, the first node will wait a random time before trying to again send the frame thereof.

Each node is further configured to implement a monitoring method which serves to reconfigure the network when same enters the CSMA/CD operating mode, in order to return to the PLCA operating mode. The method is, e.g., implemented periodically in the network 10. In other words, the steps 110 to 140 described below may be looped back at a predetermined periodicity.

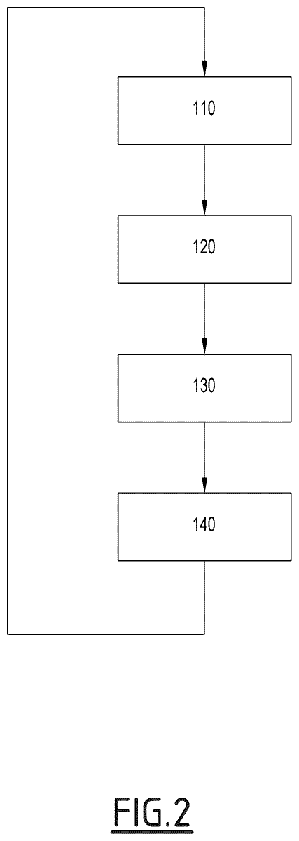

The method will henceforth be explained with reference to FIG. 2 which shows an organization chart of the steps thereof.

Initially, it is considered that the network 10 operates according to the PLCA operating mode and the set of nodes 12-0, . . . , 12-N are apt to send and receive frames.

It is also considered that the steps described hereinbelow are carried out by each of the nodes 12-0, . . . , 12-N. Thereby, the steps will be described with reference to a single node (e.g., node 12-1), knowing that all the other nodes are apt to implement the same steps.

During an initial step 110, the node 12-1 retrieves an internal state making it possible to describe the current operating mode of the network 10 from the point of view of the node.

More particularly, the internal state indicates the operating mode of the network, either the PLCA operating mode or the CSMA/CD operating mode. Such internal state also indicates whether that node is receiving or sending a synchronization signal.

More particularly, the internal status may indicate the PLCA operating mode and whether the node is sending a synchronization signal. In other words, the internal state indicates that the corresponding node is the master node in the network 10.

According to another example, the internal state may indicate that the network is in the PLCA operating mode and the corresponding node receives a synchronization signal. In such a case, the corresponding node is a slave node, which then receives a synchronization signal from a master node.

The internal status may also indicate that the network 10 is operating in the CSMA/CD mode and that the corresponding node does not receive any signaling signal. Such case then corresponds to a normal operation of the node in the CSMA/CD operating mode of the network 10. According to yet another example, the internal state of the node may indicate that the network 10 is in the CSMA/CD operating mode while the corresponding node receives or sends a synchronization signal. The latter state indicates a malfunction of the network which will then be treated as will be explained with reference to the following steps of the method.

Advantageously, the internal state of the node is kept in the internal register thereof.

Retrieving such a state thus includes the retrieving of the state from the internal register of the node 12-1.

During the following step 120, the node 12-1 sends the internal state thereof to all the other nodes 12-0, 12-2 to 12-N.

To this end, the node 12-1 integrates the identifier thereof as well as the internal state in each frame sent by the node in the network 10.

To this end, different techniques are possible.

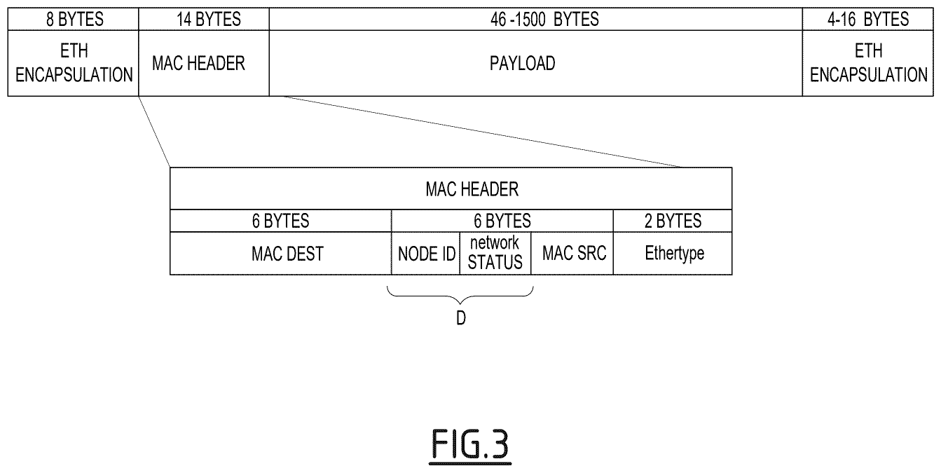

According to a first technique illustrated in FIG. 3, the node 12-1 integrates additional data D in a header of each frame. The header corresponds, e.g., to the MAC HEADER type of header. The additional data D can be integrated more particularly in the field indicating the origin of the frame, called the MAC Source field.

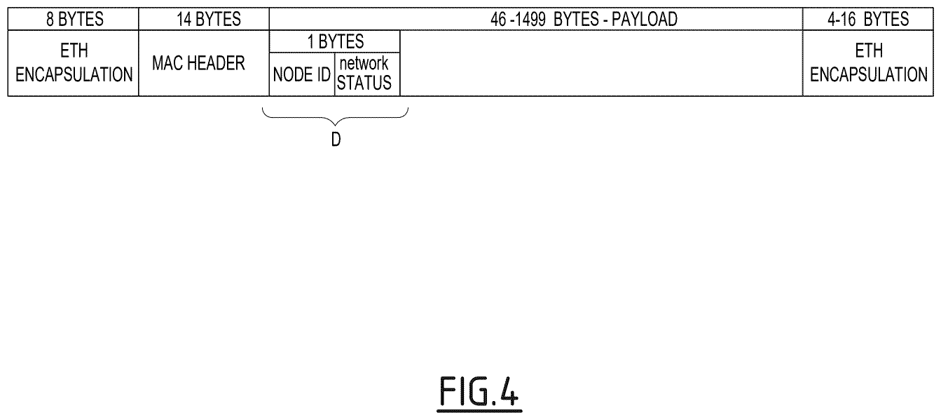

According to a second technique illustrated in FIG. 4, the additional data D are integrated into the Payload (useful load) of the corresponding frame.

According to yet another technique (not illustrated), the additional data D can be integrated into a field independent of the field of application Payload data. Thereof involves the decrease of the maximum size of the Payload field.

During the following step 130, the node 12-1 analyzes the external states received from the other nodes of the network 10 or, if appropriate, the case when the external states have not been received. More particularly, external states refer to the internal states determined by the other nodes of the network and then sent to the corresponding node using the frames sent by the nodes.

The analysis step 130 serves to determine whether it is necessary in particular to reconfigure the node 12-1 or else to maintain the current configuration thereof during the step 140, in order to re-establish, if need be, the PLCA operating mode of the network 10.

Different examples of implementation of the steps 130 and 140 are possible. Moreover, as will be explained hereinafter, it is necessary in certain cases to implement the steps 130 and 140 several times in order to reach the PLCA operating mode of the network 10.

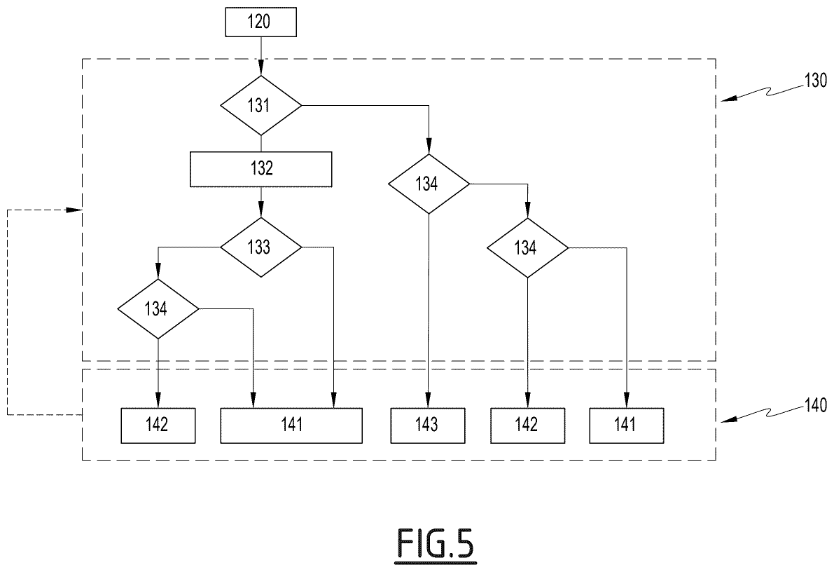

An example of possible implementation of such steps is illustrated in FIG. 5.

With reference to FIG. 5, the analysis step 130 includes a first sub-step 131 during which the node 12-1 waits for the reception of the external states coming from the other nodes. When no external state, i.e., no frame, is received from the other nodes at the end of a first time interval, the node 12-1 implements the sub-step 132 during which same forces the switch into the CSMA/CD operating mode. The node 12-1 again then awaits the reception of the external states, i.e., the frames coming from the other nodes, during the sub-step 133.

When, at the end of a second time interval which is, e.g., equal to the first time interval, the node 12-1 still does not receive a frame from the other nodes, it is considered that the node is faulty and should then be deactivated during step 140. In FIG. 5, the deactivation of the node then corresponds to the action identified by the reference 141. If, in the opposite case, the node 12-1 receives frames coming from the other nodes, the node implements a validation sub-step 134 of the external statuses received. The validation sub-step 134 will be explained in more detail thereafter.

When, at the end of step 134, the status of the network indicating the CSMA/CD operating mode considered invalid, it is again considered that the node is faulty and it is then deactivated during step 140 by the action 141.

When, on the other hand, the status indicating the operating mode of the CSMA/CD network is considered valid during step 134, it is considered that the network 10, and mode the corresponding nodes 12-0 to 12-N, have to be reconfigured during step 140 in order to re-establish the PLCA operating mode.

With reference to FIG. 5, such action is then denoted by the reference 142 and will be explained in more detail hereinafter.

When, during the sub-step 131, the node 12-1 receives frames coming from the other nodes, i.e., from the external states, same implements the sub-step 134 of validating the PLCA status of the network 10.

When the status is considered valid at the end of the sub-step 134, it is considered that the network 10, and more particularly the node 12-1, operates normally in the PLCA operating mode and during the step 140, the current configuration of the network is maintained.

With reference to FIG. 5, the action of maintaining the current configuration of the network corresponds to the reference 143.

If, on the other hand, after the first implementation of the validation step 134, the state indicating the PLCA operating mode of the network 10 is considered invalid, the node 12-1 again implements the validation step 134 during which same verifies this time the validity of the state indicating the CSMA/CD operating mode.

When, at the end of the second implementation of the sub-step 134, the state indicating the CSMA/CD operating mode is considered to be valid, it is considered that the network 10 and in particular the node 12-1 have to be reconfigured during the step 140 in order to re-establish the PLCA operating mode of the network 10.

To this end, the node 12-1 implements during step 140 the action 142 which will be explained in detail thereafter.

If, on the contrary, at the end of the second implementation of the validation sub-step 134, the state indicating the CSMA/CD operating mode is considered invalid, it is considered that the node 12-1 is faulty and has to be deactivated during step 140. Thereby, during step 140, the action 141 including the deactivation of the node is then implemented.

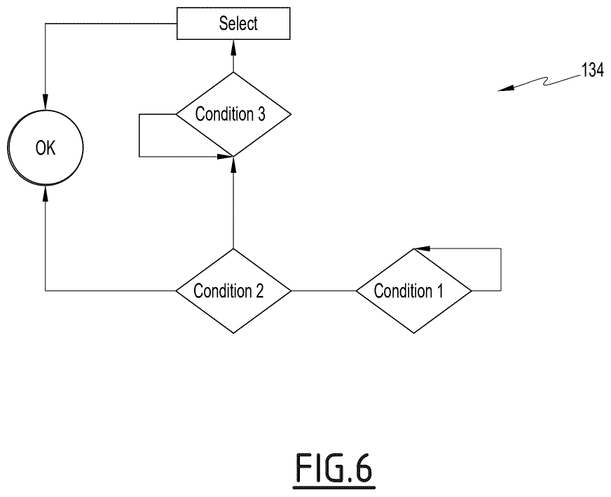

FIG. 6 illustrates an example of the implementation of the sub-step 134 for validating the external states received by the corresponding node 12-1.

In general, the validation sub-step 134 includes comparing the external states received from different nodes and selecting the valid state corresponding to a common state according to a majority of the external states received.

Thereby, according to the example of FIG. 6, sub-step 134 includes the verification of three conditions.

The first condition (Condition 1 in FIG. 6) is met when the node 12-1 receives two external statuses coming from the two different nodes.

When this is not the case, node 12-1 goes on hold until receiving the external statuses from two different nodes.

When two statuses originating from two different nodes are received, the node 12-1 verifies the second condition (Condition 2 in FIG. 6) which consists in comparing the statuses received.

In the case of identical statuses, node 12-1 concludes that the status is valid. When, on the other hand, the second condition is not satisfied, i.e., the statuses received from the two different nodes are not identical, the node 12-1 implements the third condition (Condition 3 in FIG. 6) during which same verifies whether the node has received an external status from another node different from the first two nodes. When this is not the case, the node 12-1 waits for such a status from a third node different from the first two nodes.

When such is the case, the node 12-1 selects the valid state corresponding to the common state according to the majority of external statuses received. In other words, in such a case, the node 12-1 decides the valid status according to the majority.

Of course, other modes of validation of the states received are further possible. For example, it is possible to perform a double check of the states received from the same node.

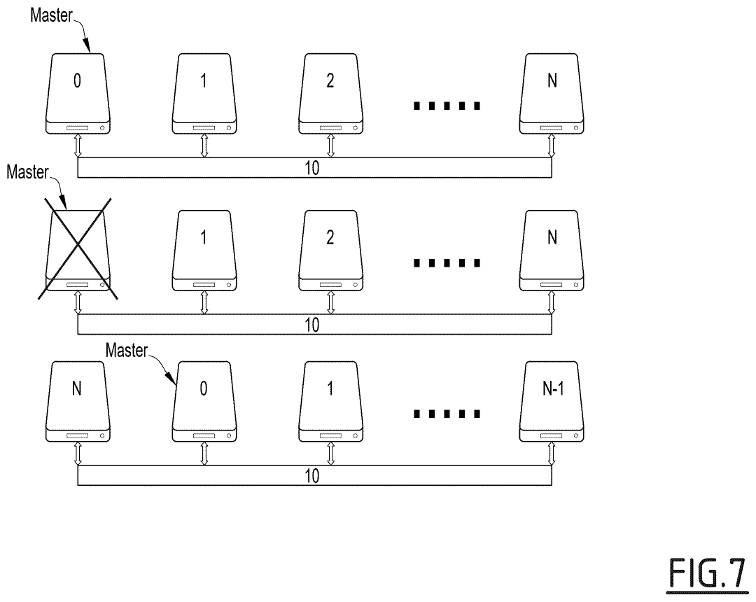

FIG. 7 illustrates the implementation of action 142 implemented during step 140.

More particularly, the action 142 includes a shift of the node identifier in order to restore the PLCA operating mode of the network 10.

The shift includes the allocation of a new identifier determined according to the maximum number of nodes in the network when the corresponding node is the master node. For the other nodes, the shift includes reducing the identifier of that node by one.

FIG. 7 illustrates, in the part A thereof, the normal operation of the network 10 according to the PLCA operating mode for nodes having identifiers ranging from 0 to N. Among such nodes, the node having the identifier 0 corresponds to the master node which is apt to send a synchronization signal to the other nodes.

FIG. 7 illustrates, in the part B thereof, the case when the node with the identifier 0 needs to be reconfigured and a new master node selected. To this end, and as illustrated in part C of FIG. 7, the preceding master node receives the identifier corresponding, e.g., to the maximum identifier of the nodes in the network and thereby becomes a slave node. In such a case, the identifiers of all other nodes are decreased by one so that the previous node with the identifier number 1 becomes the node with the identifier number 0. Thereby, the node becomes the new master node.

The other nodes, i.e., the preceding nodes with identifiers ranging from 2 to N, remain the slave nodes, but change the identifiers thereof, which now range from 1 to N-1.

When, after a first shift of the identifiers, there is no node having the identifier 0, the shift operation is performed once again until such a node having the identifier 0 is obtained. The new shift operation is performed during a new implementation of step 140 and of the action 142, which are then performed following a new implementation of the analysis step 130.

Thereby, the network 10 can operate again according to the PLCA operating mode. In such a case, the new master node receives and sends the corresponding synchronization signal.

In this way, it can be understood that the present invention has a certain number of advantages.

More particularly, the invention initially serves to reliably detect a fault on the network. The detection is called reliable because same comes from a redundancy of the different states coming from different nodes. Thereof then makes substantially negligible the probability that the detection is false. In a second step, the invention allows the network to be reconfigured to maintain and find the PLCA mode, which is then the desired operating mode.

The invention further implements a technique for verifying sent external states in order to protect the integrity of the network.

During the reconfiguration of the network, the invention serves to disable a malfunctioning node to prevent any anomaly on the network caused by the node.

Finally, the invention also serves to shift the identifiers of the nodes over the entire network to allow the PLCA operating mode to recover as quickly as possible. Such operation allows the shift to be repeated several times in case of multiple failures. Such multiplicity of reconfiguration possibilities makes the network more reliable in an avionics context since the probability of having a system of multiple similar failures is low and decreases with the number of failures.

The network can thereby be efficiently used, in particular in the field of avionics, to replace existing networks, e.g., networks as per the standard ARINC 429.

1. A method for monitoring a Half Duplex Ethernet network comprising a plurality of nodes and having a PLCA operating mode and a CSMA/CD operating mode, each node being defined by an identifier, in the PLCA operating mode, a master node sending to all the other nodes a synchronization signal to send the frames thereof, in the CSMA/CD operating mode, all nodes sending the frames thereof at random time intervals, the method comprising the following operations implemented by each node:
retrieving an internal state of the node describing the network operation mode;
transmitting the internal state to all the other nodes, comprising integrating the internal state into each frame sent by the corresponding node;
analyzing the external states received corresponding to the internal states sent by other nodes; and
based on said analyzing, reconfiguring the node or conserving the current configuration thereof.

2. The method according to claim 1, wherein each internal state indicates the operating mode of the network seen by the corresponding node.

3. The method according to claim 2, wherein each internal state further indicates whether the corresponding node receives or sends a synchronization signal.

4. The method according to claim 1, wherein said reconfiguring comprises deactivating the node or shifting the identifier thereof.

5. The method according to claim 4, wherein said shifting comprises:
allocating a new identifier chosen according to the maximum number of nodes in the network when the corresponding node is the master node; and
reducing the identifier by “1” for all other cases.

6. The method according to claim 1, wherein said analyzing comprises validating comprising selecting a valid state from the set of received states.

7. The method according to claim 6, wherein:
said analyzing comprises analyzing at least three external states from different nodes; and
said validating comprises comparing the external states received and the selection of the valid state corresponding to a common state of a majority of the external states received.

8. The method according to claim 6, wherein when the valid state indicates:
the PLCA operating mode, the current configuration of the corresponding node is conserved;
the CSMA/CD operating mode, the corresponding node is reconfigured by a shift of the identifier thereof; and
none of the operating modes, the corresponding node is reconfigured by a deactivation of the node.

9. The method according to claim 8, wherein said analyzing comprises activating the CSMA/CD operating mode when the corresponding node receives no frames in a first time interval.

10. The method according to claim 9, wherein following said activating, said reconfiguring comprises shifting the identifier of the corresponding node when the node receives at least one frame in a second time interval, and deactivating the node otherwise.

11. A Half Duplex Ethernet network comprising a plurality of nodes and having a PLCA operating mode and a CSMA/CD operating mode, each node being defined by an identifier, in the PLCA operating mode, a master node sending a synchronization signal to all the other nodes to issue the frames thereof, in the CSMA/CD operating mode, all nodes issuing the frames thereof at random time intervals, and each node being configured to implement the method according to claim 1.
